(19) United States
(12) Patent Application Publication
(10) Pub. No.: US 2008/0072769 A1
(43) Pub. Date: Mar. 27, 2008

(54) PAN WITH DROP-IN BAKING WELLS

(75) Inventor: Reid Hecker, Ronkonkoma, NY (US)

Correspondence Address: TROUTMAN SANDERS LLP, 600 PEACHTREE STREET , NE, ATLANTA, GA, 30308, US

(73) Assignee: Lifetime Brands, Inc., Garden City, NY (US)

(21) Appl. No.: 11/860,434

(22) Filed: Sep. 24, 2007

Related U.S. Application Data
(60) Provisional application No. 60/826,849, filed on Sep. 25, 2006.

(51) Int. Cl. A47J 37/01; A47G 29/00; B65D 1/34; A47J 27/00

(52) U.S. Cl. 99/426; 206/564; 211/71.01; 220/573.1

(57) ABSTRACT

A pan with removable drop-in baking wells. A main support structure defines a plurality of apertures in which a plurality of baking wells of various shapes and sizes can be temporarily inserted during use. The main support structure includes a vertical side wall and support foot that engages a countertop, oven rack, or other surface. Accordingly, the bottoms of the baking wells do not come in contact with the countertop, oven rack, or other surface, because the baking wells are adequately supported by the main support structure.

### CROSS REFERENCE TO RELATED APPLICATION

This application claims benefit under 35 U.S.C. § 119(e) of U.S. Provisional Patent Application Ser. No. 60/826,849 filed 25 Sep. 2006, which priority application is hereby incorporated by reference.

### BACKGROUND OF THE INVENTION

1. Field of the Invention

The present invention relates generally to a baking pan with wells, and in particular to a baking pan with drop-in wells of varying shapes and sizes.

2. Description of Related Art

Food products, such as muffins and cupcakes, are common food items often created at home or made at a commercial establishment. Muffins, for example, are a popular breakfast and snack choice and can vary in flavor based on the many available recipes. Traditional muffin flavors include blueberry, chocolate, chocolate-chip, banana-nut, poppy-seed, lemon, bran, and other sweet and salty flavors. Such muffins can also include various fruits, nuts, and other ingredients that are generally mixed into the muffin batter prior to baking. Cupcakes can also be made in a variety of colors and flavors, such as vanilla, chocolate, carrot-cake, red-velvet, and other suitable flavors.

When making muffins, cupcakes, and other baking products, cooks often use muffin pans having multiple baking wells or vessels that are adapted to hold batter ingredients during the baking process. The baking wells are used as a mold to assist in the formation of a muffin or cupcake as it is baking in an oven. Such muffin pans typically include four, six, eight, twelve, or sixteen baking wells of uniform size and shape.

Traditional muffin pans are generally made completely of sheet metal. Such pans have a top surface with more or less cylindrical baking wells that extend below the top surface. These baking wells are generally an integral part of the top surface of the pan and are either formed out of the same piece of material or are permanently attached to the top surface of the pan. The baking wells of the muffin pan are generally of the same shape and/or size.

More recently, muffin pans made completely of silicone have become well known in the art. Silicone pans are generally shaped the same as a sheet metal muffin pan, but are made of a different material. The silicone baking wells are integrally formed with the silicone top surface of the muffin pan. As silicone muffin pans are somewhat flexible, some are available with separate structures, for example, made out of metal wire for extra support, thereby making it easier to move in and out of the oven. These silicone muffin pans with and without supporting structures are common today and can easily be found at home or in kitchen product stores and catalogs.

One known muffin pan includes a generally flat metal sheet with circular holes defined therein. Silicone baking wells having an upper and lower lip, with a small space between the two lips, are attached to the metal sheet by sandwiching the metal edge surrounding the circular holes of the pan into the small space contained between the two lips of the baking wells. Once the baking wells are secure in the pan, the baking wells do not move up or down relative to the top surface of the metal pan. Accordingly, the bottom of the baking wells can come in contact with countertops and oven racks during use. The metal pan, however, does not come into contact with countertops or oven racks during use, because the baking wells are secured thereto and define the bottom of the muffin pan (e.g., the baking wells support the top surface of the muffin pan during use).

Unfortunately, securing the baking well with the top surface of the metal pan can be difficult and time consuming to the user. The two lips of the non-rigid baking well must be flexed around the edge of the pan surrounding the circular holes to ensure proper attachment to the metal pan. If not secured correctly, the baking well could fall down through the opening of metal pan, which could compromise the overall stability of the muffin pan.

Another known muffin pan includes a generally flat metal sheet with circular holes defined therein. Silicone baking wells are permanently attached to the metal sheet and, therefore, are not removable from the metal sheet of the pan. Accordingly, the metal pan does not come into contact with countertops or oven racks, because the bottoms of the silicone baking wells support the muffin pan when placed on the counter or within an oven. As such, the silicone baking wells must be rigid enough themselves to adequately hold up the metal sheet of the muffin pan.

What is needed, therefore, is a pan with drop-in baking wells that allows for easy use of one or more baking wells of various shapes and sizes, such that the pan does not depend on the baking wells for support when placed on a countertop or oven rack. Further, what is needed is a pan with drop-in baking wells that does not require permanent or rigid attachment of the baking wells to the pan during use. It is to such a device that the present invention is primarily directed.

### BRIEF SUMMARY OF THE INVENTION

Briefly described, in preferred form, the present invention is a cooking system comprising a main support structure having a top surface and an aperture, a support assembly for maintaining the main support structure elevated above a rest surface, and a cooking well with a bottom, the cooking well cooperatively shaped with the aperture so at least a portion of the cooking well fits through the aperture in the main support structure, and is releasably secured within the aperture, wherein the support assembly maintains the bottom of cooking well above the rest surface.

The main support structure comprises ends and sides, and the support assembly preferably comprises a side wall extending from at least one of the sides of the main support structure and a support foot extending from the side wall.

The cooking well preferably includes an upper open end with an upper lip extending therefrom, the upper lip adapted to engage a portion of the top surface of the main support structure when the cooking well is placed through the aperture. The communication of the upper lip of the cooking well with the top surface of the main support structure releasably secures the cooking well within the aperture.

In another preferred embodiment, the cooking system is a baking system that comprises a pan with removable drop-in baking wells. A main support structure defines a plurality of apertures in which a plurality of baking wells of various shapes and sizes can be temporarily inserted during use. The main support structure includes a vertical side wall and support foot that engages the rest surface, for example, a countertop, oven rack, or other surface. Accordingly, the bottoms of the baking wells do not come in contact with the countertop, oven rack, or other surface, because the baking wells are adequately supported by the main support structure above such a rest surface.

Generally, the main support structure is made of a more rigid material that can withstand a wide range of temperatures, while providing adequate support to the multiple baking wells. The baking wells are also made of a material that can with stand a wide range of temperatures, but it is not necessary for the baking wells to be as rigid as the main support structure. In a preferred embodiment of the present invention, the main support structure is made of metal and the corresponding baking wells are made of silicone.

The shape and size of the main support structure, the apertures defined by the top surface of the main support structure, and the plurality of baking wells can be of many suitable shapes and sizes. The baking wells need not be of a uniform shape and size and, therefore, provide multiple combinations of use during baking. For example, the baking wells can include small and large molds having a shape such as a circle, square, rectangle, triangle, star, and/or heart.

The plurality of apertures of the main support structure and the shape of the baking wells need not be circular. The baking wells can include an upper lip to engage with the top surface of the main support structure once the baking well is received by one of the apertures. The baking well and the aperture of the main support structure can be of many suitable shapes or sizes, such that the baking well can be adequately received by the aperture, while being supported by the corresponding upper lip of the baking well. Furthermore, the upper lip of the baking well need not be the same shape as the aperture of the main support structure, so long as the baking well can be adequately supported within the main support structure.

These and other objects, features and advantages of the present invention will become more apparent upon reading the following specification in conjunction with the accompanying drawings.

### BRIEF DESCRIPTION OF THE FIGURES

FIG. 1A illustrates a top view of a pan with drop-in baking wells in accordance with a preferred embodiment of the present invention.

FIG. 1B illustrates a bottom view of the pan of FIG. 1A.

FIG. 1C illustrates a side view of the pan of FIG. 1A.

FIG. 1D illustrates a cross-sectional view along AA of the pan of FIG. 1A.

FIG. 1E illustrates a cross-sectional view along BB of the pan of FIG. 1A.

FIGS. 2A-2F, collectively known as FIG. 2, illustrate orthographic views of multiple drop-in baking wells in accordance with preferred embodiments of the present invention.

FIGS. 3A-3B, collectively known as FIG. 3, illustrate isometric views of pans for receiving drop-in baking wells in accordance with an alternative embodiment of the present invention.

### DETAILED DESCRIPTION OF THE PREFERRED EMBODIMENTS

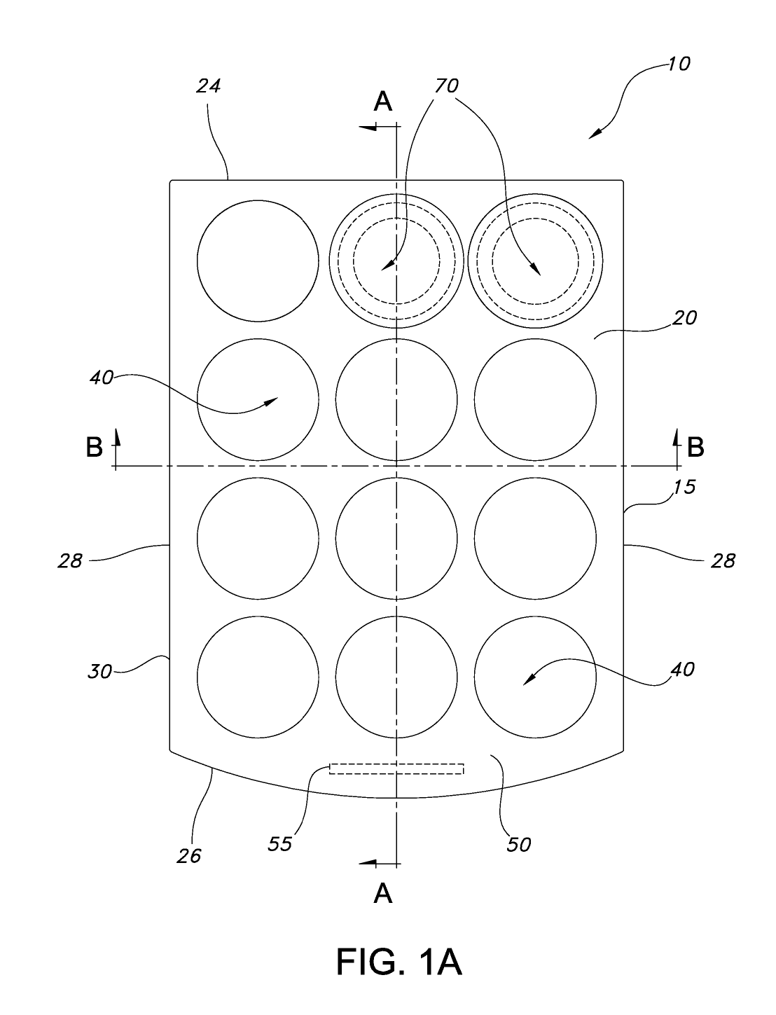

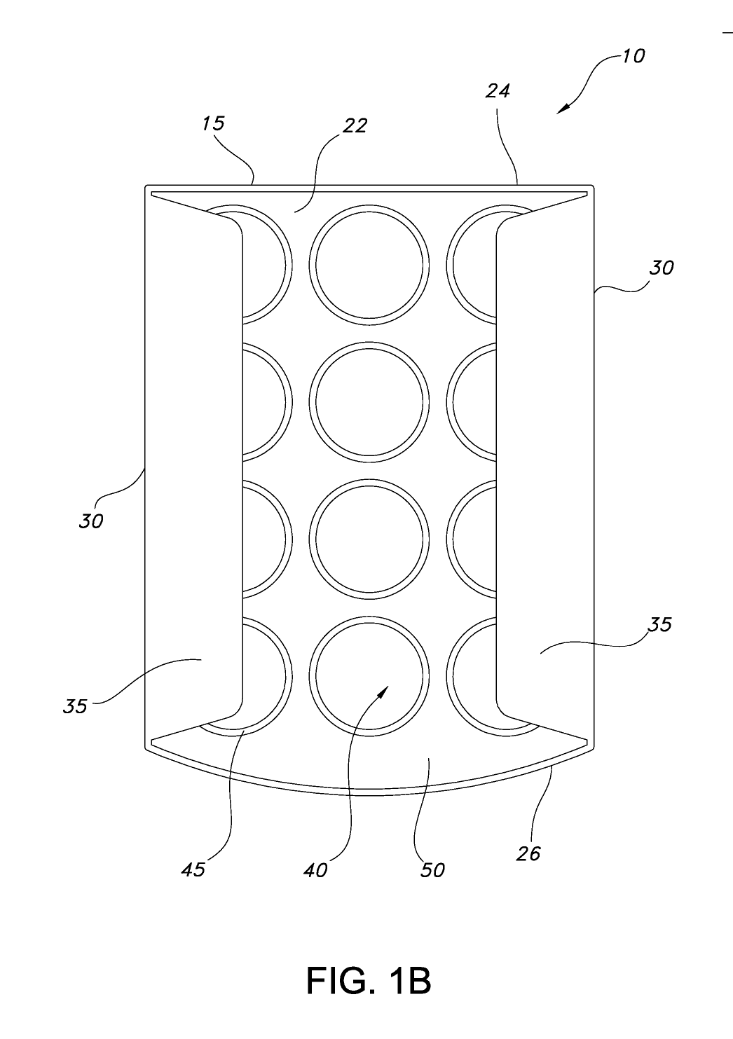

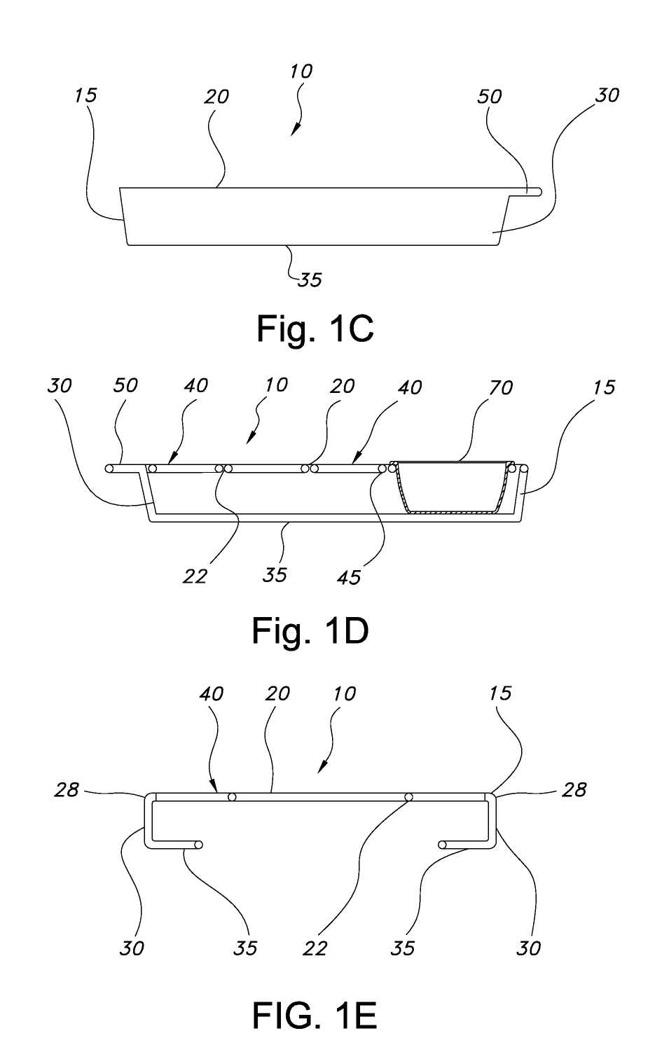

Referring now in detail to the drawing figures, wherein like reference numerals represent like parts throughout the several views, the present invention provides a pan with removable drop-in baking wells 10, as illustrated in FIG. 1 (being collectively the view of FIGS. 1A-1E), which permits a user to bake muffins, cupcakes, and other food items in a customary and normal manner, but with additional benefits over traditional muffin pans. The pan with removable drop-in baking wells 10 is designed for receiving baking contents, such as batter, gelatin, or mix, within easily removable baking wells 70 (also referred to herein as alternatively cups, vessels, or receptacles) having a variety of available shapes and sizes, while providing a main support structure 15 for maintaining the baking wells 70 in a predetermined position during use.

Individual baking wells 70 can be easily separated from the main support structure 15 of the pan. During use, one or more individual baking wells 70 can be inserted into an aperture 40 defined by the main support structure 15, such that gravity pulls a baking well 70 toward the main support structure 15, thereby allowing a portion of the baking well 70 to engage with a portion of the main support structure 15. Generally, the baking wells 70 are not permanently attached to the main support structure 15 during use of the present invention.

As described more fully below, each individual baking well 70 can be of a different size and/or shape and can comprise a common interfacing structure for adequately engaging a standard sized and shaped opening 40 of the main support structure 15. As such, many different combination options are possible utilizing one or more baking wells 70 having similar or different sizes and shapes. The easily removable baking wells 70 also allow for a user to effortlessly remove a muffin or other food product from a particular baking well 70 after baking or other preparation.

The pan 10 of the present invention can be utilized for many items such as muffins, cakes, cupcakes, rolls, gelatins, juices, doughnuts, bagels, and other baked and non-baked items. Although the description below may refer generically to the present invention as a muffin pan, it should be understood that the features of the pan 10 can be utilized for other bakery items while remaining within the scope of the present invention.

As shown in FIGS. 1A-1E, the pan with removable drop-in baking wells 10 comprises a main support structure 15 defining at least one aperture 40 therein and at least one baking well 70, which can be adequately received by the at least one aperture 40 of the main support structure 15. The main support structure 15 is adapted to adequately support the baking wells 70 during use.

The main support structure 15, when positioned generally horizontally, has a substantially planar top surface 20, a bottom surface 22, a first end 24 and a second end 26 opposite the first end, and sides 28. As shown, the ends 24, 26 need not be parallel, for example, an end 24 being relatively normal to a side 28 of a pan, and an end 26 being arcuate. Further, the sides 28 need not be parallel to one another, although shown in FIG. 1 as being so.

The main support structure 15 is formed to define a plurality of apertures 40 through the top surface 20. The main support structure 15 further includes at least one lateral side wall 30 positioned at a side 28 of the main support structure 15. A lateral side wall 30 generally extends downwardly from the top surface 20 of the main support structure 15 and, therefore, is generally perpendicular to the top surface 20. The one or more lateral side walls 30 extend a predetermined distance downwardly from the top surface 20, such that the height of the lateral side walls 30 is greater than the height of all the available baking wells 70.

The main support structure 15 can further comprise at least one support foot 35 positioned at the lower end of a lateral side wall 30. The support foot 35 generally extends inwardly from the bottom edge of the lateral side wall 30, such that the support foot 35 is generally perpendicular to the lateral side wall, but generally parallel to the top surface 30 of the main support structure 15. The support foot 35 can extend a predetermined distance inwardly from the lateral side wall 30 to provide adequate footing for the main support structure 15 when placed on a countertop or oven rack. During use, the bottom of the support foot 35 engages the countertop or oven rack, not the bottom of the baking wells 70.

In one embodiment of the present invention, the edge that connects the lateral side wall 30 with the top surface 15 and the edge that connects the lateral side wall 30 with the support foot 35 can be rounded to reduce the number of sharp edges present on the main support structure 15. Furthermore, the top surface 20 of the main support structure 15 can also include protrusions, ridges, or other structures (not shown) to effectively increase the rigidity of the main support structure 15 and minimize undesired flexing.

For added strength and support, the main support structure 15 can also include a support ridge 45 along the perimeter of each defined aperture 40. The support ridge 45 provides adequate strength to the top surface 20 and bottom surface 22 of the main support structure 15 for the carrying of a plurality of baking well 70 during use.

The main support structure 15 can further include a carrying handle or lip portion 50 defined by the top surface 20 and bottom surface 22. The carrying handle or lip portion 50 is generally positioned between the first and second end of the main support structure 15 to allow a user to grab the main support structure 15 during use (for example, when moving the main support structure 15 into and out of the oven). The carrying handle or lip portion 50 can include indicia 55 positioned on the top surface 20 of the main support structure 15 to provide instructions to the user or to advertise a brand name. For example and not limitation, the indicia 55 can indicate to the user which side of the main support structure 15 should be facing upwards.

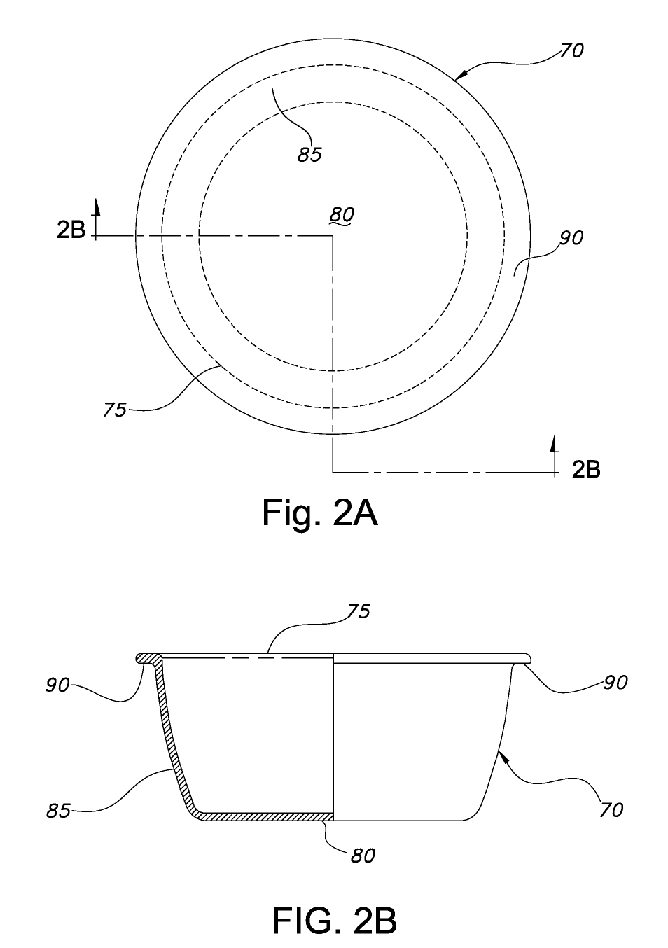

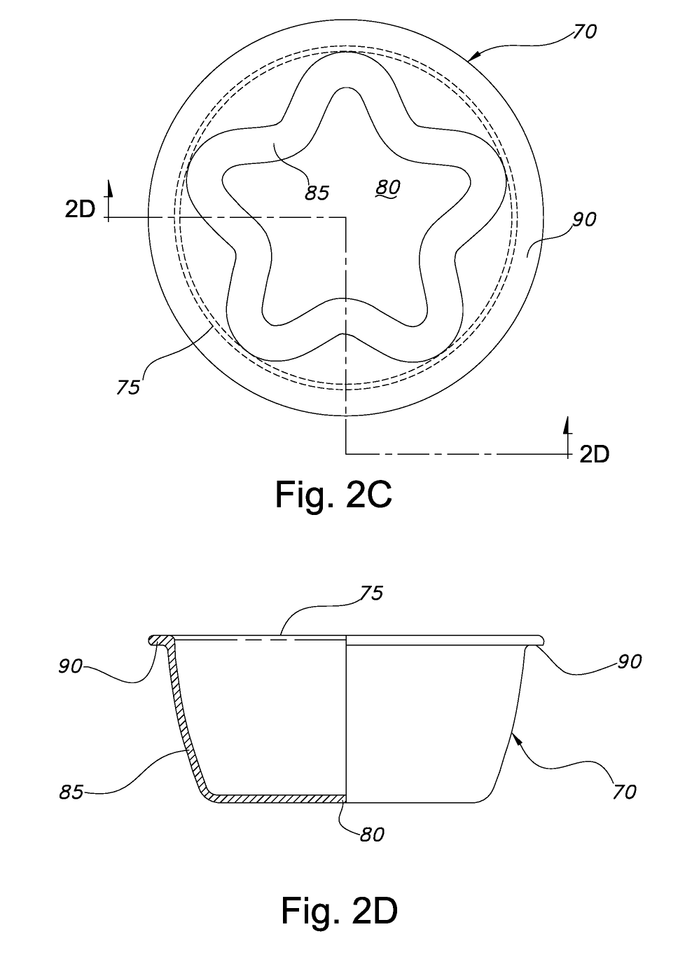

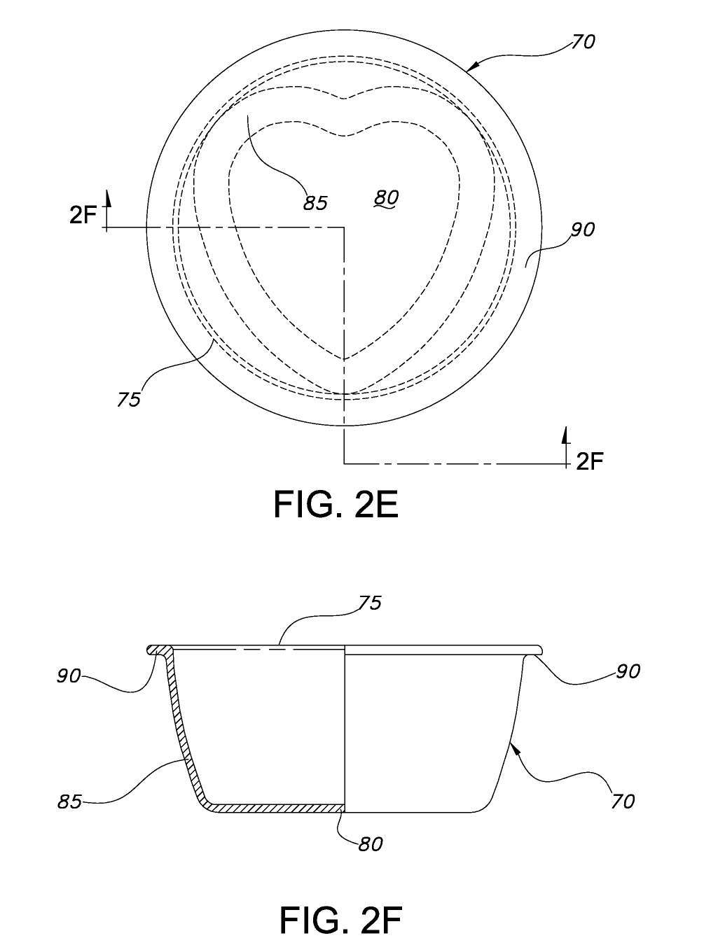

As illustrated in FIGS. 2A-2F, each baking well 70 can include an upper open end 75, a lower closed end 80, and a peripheral wall 85 extending from the upper open end 75 to the lower closed end 80. Generally, the upper open end 75 is larger in diameter than the lower closed end 80. Accordingly, the peripheral wall 85 defines a slight taper from the upper open end 75 and the lower closed end 80. Such tapering of the baking well 70 allows multiple baking wells 70 to be nested or stacked upon each other during non-use.

Each baking well 70 further includes an upper lip 90 positioned along the perimeter of the upper open end 80. The upper lip 90 extends generally outwardly from the upper open end 80 and, therefore, is generally perpendicular to the peripheral wall 85. The upper lip 90 is adapted to engage a portion of the top surface 20 of the main support structure 15 when the baking well 70 is placed within an aperture 40. More specifically, the upper lip 90 effectively increases the outside diameter of the upper open end 75 of the baking well 70, such that the outside diameter is slightly greater than the diameter of the defined aperture 40 of the main support structure 15. Accordingly, the upper lip 90 of the baking well 70 ensures that the baking well 70 does not fall through the aperture 40 of the main support structure 15 during use.

The number of baking wells 70 to be used with the main support structure 15 generally corresponds to the number of apertures 40 in the top surface 20, but could include additional baking wells 70 for added combinations of use. For example, the top surface 20 of the main support structure 15 may have four, six, nine, or twelve apertures 40 arranged in a convenient manner on the top surface 20. The number of baking well 70, therefore, could include four, six, nine, twelve, or other convenient or desired numbers, thereby providing for multiple combinations of use of the pan with removable drop-in baking wells 10.

The baking wells 70 are generally sized and shaped to hold an amount of material and to retain a food product once baked. The size of the baking wells 70 can be of many suitable sizes, but generally have a height less than the height of a lateral side wall 30 of the main support structure 15. The size of the baking wells 70, for example, may take into account the number of baking wells 70 possibly utilized within the main support structure 15, as well as the shape and size of the main support structure 15 and other corresponding baking wells 70. Generally, the baking wells 70 can be sized to hold as little or as much batter or dough as is desired for baking.

As illustrated in FIGS. 2C-2F, the shape of the baking wells 70 is not limited to a circular shape and, therefore, can be defined as many suitable shapes for baking. Example shapes of usable baking wells 70 include, but are not limited to, circles, squares, ovals, triangles, stars, and hearts.

Although, as illustrated, the main support structure 15 is generally rectangular in shape, one skilled in the art will recognize that the main support structure 15 can be of various shapes and/or sizes without departing from the scope of the present invention. Moreover, the overall dimensions of the main support structure 15 can be many suitable sizes, but is typically about 14 to 15 inches long and about 10 to 11 inches wide. This size may be more or less depending on the desired overall size of the oven or other storage container into which the main support structure 15 must fit. Also, the shape of the main support structure 15 can be many suitable shapes, such as rectangular, square, circular, triangular, or other appropriate shape.

During use, the baking wells 70 are placed into the openings 40 of the main support structure 15, such that the upper lip 90 or outside perimeter of each baking well 70 is supported by the top surface 20 of the main support structure 15, thereby preventing the baking well 70 from falling completely through the opening 40. In one embodiment, the baking well 70 fits snugly into the aperture 40 of the top surface 20 of the main support structure 15, but is not generally attached to the main support structure 15.

In preferred form, the openings 40 of the main support structure 15 are generally circular in shape, such that the upper lip 90 or outer perimeter of each baking well 70 forms a circle of slightly larger diameter than the opening 40 of the main support structure 15. Accordingly, the baking well 70 can slide (lower closed end 80 first) through the opening 40 of the main support structure 15 until the upper lip 90 of the baking well 70 engages the top surface 20 of the main support structure 15. The larger diameter of the upper lip 90 of the baking well 70, therefore, is supported by the smaller diameter of the opening 40 of the main support structure 15.

The openings 40 of the main support structure 15 and the shape of the baking wells 70 need not be circular. The upper lip 90 of the baking well 70 and the opening 40 of the main support structure 15 can be of many suitable shapes or sizes, such that the baking well 70 can be adequately received by the opening 40 of the main support structure 15 and supported by the corresponding upper lip 90 of the baking well 70. Furthermore, the upper lip 90 of the baking well 70 need not be the same shape as the opening 40 of the main support structure 15, so long as the baking well 70 can be adequately supported by the upper lip 90 and main support structure 15. Additionally, the baking well 70 need not be supported by the main support structure 15 along the entire perimeter of the upper lip 90, as long as the upper lip 90 engages the top surface 20 of the main support structure 15 in enough locations to keep the baking well 70 level with the top surface 20 of the main support structure 15 and prevent the baking well 70 from falling completely through the opening 40. Although the baking wells 70 cannot extend beyond a certain distance below the opening 40 of the main support structure 15, the baking wells 70 can be easily raised up from the main support structure 15.

The formation of the main support structure 15 ensures that the lower closed end 80 (or bottom) of the baking wells 70, once placed into the openings 40, do not encounter other objects except for perhaps the support foot 35 of the main support structure 15. Accordingly, the baking wells 70 do not come into contact with the countertop or an oven rack during use of the present invention. The height of the lateral side walls 30 (e.g., the height of the main support structure 15), therefore, is greater than the height of the deepest available baking well 70.

One skilled in the art will recognize that the baking wells 70 of the present invention can be used with many product materials requiring a mold structure. Accordingly, the pan and drop-in baking wells 10 of the present invention can be used for foods such as cakes, muffins, cookies, brownies, gelatin, popsicles, and other food products that require a mold structure. Further, the pan and drop-in baking wells 10 can be used for non-food products such as candle or soap making. As such, the pan and drop-in baking wells 10 can be used in a manner that requires no baking whatsoever.

The main support structure 15 and associated baking wells 70 are made from a material that can withstand oven temperatures during baking. Such temperatures generally include a range from about 100° F. to about 450° F. (or about 38° C. to about 232° C.). Higher or lower temperatures may be used depending on the ingredients used in baking. Further, the main support structure 15 and associated baking wells 70 can be made of a material that can also withstand cold temperatures when, for example, the present invention is placed in a refrigerator or freezer. Accordingly, the material can also withstand temperatures ranging from about −10° F. to about 60° F. (or about −23° C. to about 15° C.).

The main support structure 15 is preferably made of metal, in order to both withstand oven temperatures and provide proper support for the baking wells 70. The main support structure 15 can be made out of other materials that can withstand oven temperatures, while providing a rigid support for the baking wells 70.

The baking wells 70 can be constructed of a material that can withstand oven temperatures without deforming or damage, but the baking wells 70 need not be completely rigid. The baking wells 70 are preferably made out of silicone for easy formation into various shapes and/or sizes and because silicone can withstand high temperatures encountered within an oven. The baking wells 70 can also be made out of metal, plastic, or other suitable materials that can withstand oven temperatures. The baking wells 70 can be rigid enough to hold a predetermined quantity of material for baking and rigid enough to ensure that the baking wells do not fall through the openings 40 of the main support structure 15.

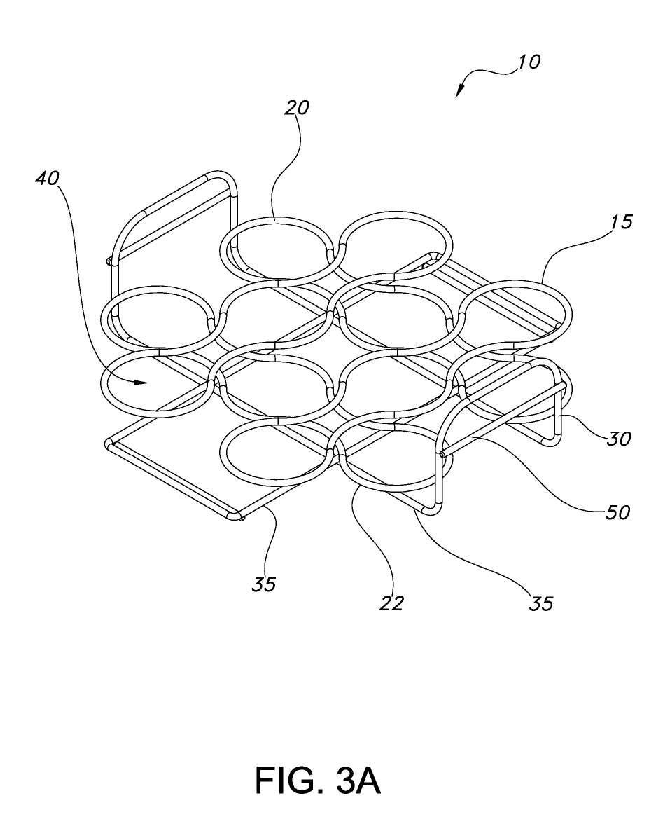

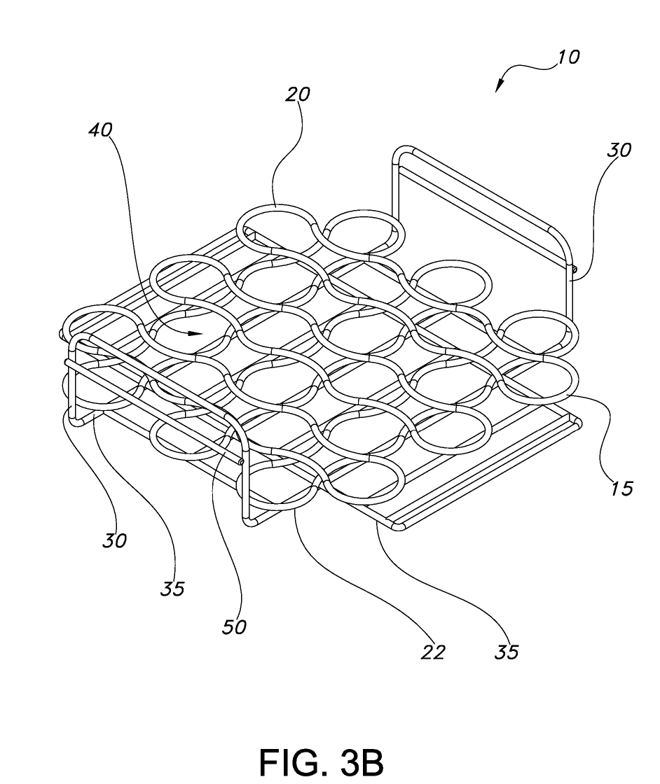

In an alternative embodiment of the present invention, as illustrated in FIGS. 3A-3B, the main support structure 10 can comprise of a wire framework that defines a top surface 20, a bottom surface 22, a lateral side walls 30, and at least one support foot 35. In this embodiment, the lateral side walls 30 assist in maintaining the top surface 20 a predetermined distance above the support foot 35. Further, the lateral side walls 30 can extend above the top surface 20 and include a carrying handle 50 to assist in the movement of the main support structure 15 during use. The wire framework of the top surface 20 defines a plurality of apertures 40 that are adapted to receive baking wells 70 of various shapes and sizes.

The support foot 35 generally extends inwardly from the lateral side walls 30. The support foot 35 can extend a partial distance under the top surface 20, such that the support foot 35 is generally parallel with the top surface 20 and generally perpendicular with the lateral side walls 30. Also, the support foot 35 can extend from a first lateral side wall 30 at one end of the main support structure 15 to a second lateral side wall 30 at another end of the main support structure 15. Accordingly, the support foot 35 can effectively connect the two lateral side walls 30 of the main support structure 15. Further, the support foot 35 can include extensions that extend outwardly from the center of the support foot 35 towards the sides of the main support structure 15 adjacent the first and second lateral side walls 30. Such a configuration provides a generally X-shape for the support foot 35. One skilled in the art will recognize, however, that the support foot 35 can be of many shapes or designs and still adequately maintain the main support structure 15 in a level position when placed upon a countertop or oven rack.

The wire framework can be configured to define apertures 40, within the top surface 20 of the main support structure 15, having varying sizes and shapes. Accordingly, the present invention is not limited to the circular shape and size illustrated in FIGS. 3A-3B. Further, the wire framework of the present invention can define one or more desired apertures 40 within the top surface 20 of the main support structure 15.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A cooking system comprising:
a main support structure having a top surface and an aperture;
a support assembly for maintaining the main support structure elevated above a rest surface; and
a cooking well with a bottom, the cooking well cooperatively shaped with the aperture so at least a portion of the cooking well fits through the aperture in the main support structure, and is releasably secured within the aperture;
wherein the support assembly maintains the bottom of cooking well above the rest surface.

2. The cooking system of claim 1, wherein the main support structure comprises at least two sides, and wherein the support assembly comprises a side wall extending from at least one of the sides of the main support structure and a support foot extending from the side wall.

3. The cooking system of claim 1, wherein the cooking well comprises an upper open end with an upper lip extending therefrom, the upper lip adapted to engage a portion of the top surface of the main support structure when placed through the aperture, the communication of the upper lip of the cooking well with the top surface of the main support structure releasably securing the cooking well within the aperture.

4. A baking system comprising:
a main support structure having a top surface and a plurality of apertures;
a support assembly for maintaining the main support structure elevated above a rest surface; and
one or more baking wells, each baking well having an upper open end, a lower closed end, and a peripheral wall extending from the upper open end to the lower closed end;
each baking well cooperatively shaped with at least one of the apertures so at least a portion of the baking well fits through an aperture in the main support structure, and is releasably secured within the aperture;
wherein the support assembly maintains the bottom of each cooking well above the rest surface.

5. The baking system of claim 4, wherein at least one of the baking wells comprises a mold having a shape of a circle.

6. The baking system of claim 4, wherein at least one of the baking wells comprises a mold having a shape of a square.

7. The baking system of claim 4, wherein at least one of the baking wells comprises a mold having a shape of a rectangle.

8. The baking system of claim 4, wherein at least one of the baking wells comprises a mold having a shape of a triangle.

9. The baking system of claim 4, wherein at least one of the baking wells comprises a mold having a shape of a star.

10. The baking system of claim 4, wherein at least one of the baking wells comprises a mold having a shape of a heart.

11. The baking system of claim 4, wherein the baking wells comprise silicone.
